(19) United States
(12) Patent Application Publication
(10) Pub. No.: US 2021/0092500 A1
(43) Pub. Date: Mar. 25, 2021

(54) PACKAGE STRUCTURE OF SOUND PRODUCING DEVICE AND MANUFACTURING METHOD THEREOF

(71) Applicant: xMEMS Labs, Inc., Los Altos, CA (US)

(72) Inventors: Chiung C. Lo, San Jose, CA (US); JengYaw Jiang, Saratoga, CA (US); David Hong, Los Altos, CA (US); Lei Chen, Hayward, CA (US); Jemm Yue Liang, Sunnyvale, CA (US)

(21) Appl. No.: 16/699,078

(22) Filed: Nov. 28, 2019

Related U.S. Application Data
(60) Provisional application No. 62/903,914, filed on Sep. 22, 2019.

(51) Int. Cl. H04R 1/02; H04R 31/00

(52) U.S. Cl. CPC H04R 1/025; H04R 31/006; H04R 1/023

(57) ABSTRACT

A package structure of a sound producing device includes a base, a cap, a chip and a chamber. The cap is disposed on the base. The chip is disposed on the base, the chip includes a thin film structure and an actuator configured to actuate the thin film structure to generate a plurality of air pulses, and the cap and the chip are on a same side of the base. The chamber is formed by the base and the cap or formed by the base, the cap and the chip; the thin film structure is disposed in the chamber. One of the base or the cap has a sound outlet opening connected to the chamber, and the air pulses propagate outwards through the sound outlet opening.

### CROSS REFERENCE TO RELATED APPLICATIONS

This application claims the benefit of U.S. provisional application No. 62/903,914, filed on Sep. 22, 2019, which is all incorporated herein by reference.

### BACKGROUND OF THE INVENTION

### 1. Field of the Invention

The present invention relates to a package structure of a sound producing device and a manufacturing method thereof, and more particularly, to a package structure of a sound producing device and a manufacturing method thereof for protecting the sound producing device having a chip.

### 2. Description of the Prior Art

A speaker driver and a back enclosure are two major design challenges in the speaker industry. It is difficult for a conventional speaker driver to cover an entire audio frequency band, e.g., from 20 Hz to 20 KHz, due to a membrane displacement D is proportional to 1/f², i.e., D∝1/f². On the other hand, to produce sound with high fidelity, a volume/size of a back enclosure for the conventional speaker is required to be sufficiently large.

To combat against the design challenges in the above, applicant has proposed a sound producing device (or an air pulse generating element), which produces sound using a plurality of pulses at a pulse rate, where the pulse rate is higher than a maximum audible frequency and the plurality of pulses is regarded as being amplitude modulated according to an input audio signal. By exploiting a low pass effect caused by ambient environment and human ear structure, a sound corresponding to the input audio signal is perceived. For example, the sound producing device (or the air pulse generating element) can be referred to U.S. application Ser. No. 16/125,761 or U.S. application Ser. No. 16/380,988, which are proposed by the applicant. Thus, the above sound producing device is able to cover the entire audio frequency band, and an enclosure volume/size of which is significantly reduced.

However, the sound producing device (or the air pulse generating element) needs to be protected due to its small sizes and fragility structures. Therefore, it is necessary to provide a package structure to protect the sound producing device (or the air pulse generating element).

### SUMMARY OF THE INVENTION

It is therefore a primary objective of the present invention to provide a package structure of a sound producing device for protecting the sound producing device having a chip, and to provide a manufacturing method of the package structure of the sound producing device.

An embodiment of the present invention provides a package structure of a sound producing device including a base, a cap, a chip and a chamber. The cap is disposed on the base. The chip is disposed on the base, wherein the chip includes a thin film structure and an actuator configured to actuate the thin film structure to generate a plurality of air pulses, and the cap and the chip are on a same side of the base. The chamber is formed by the base and the cap or formed by the base, the cap and the chip, wherein the thin film structure is disposed in the chamber. One of the base or the cap has a sound outlet opening connected to the chamber, and the air pulses propagate outwards through the sound outlet opening.

Another embodiment of the present invention provides a manufacturing method of a package structure of a sound producing device. The manufacturing method includes the following steps: providing a base; disposing a chip on the base, wherein the chip comprises a thin film structure and an actuator configured to actuate the thin film structure to generate a plurality of air pulses; and disposing a cap on the base, wherein the cap and the chip are on a same side of the base. Furthermore, a chamber is formed by the base and the cap or formed by the base, the cap and the chip, the thin film structure is disposed in the chamber, one of the base or the cap has a sound outlet opening connected to the chamber, and the air pulses propagate outwards through the sound outlet opening.

Another embodiment of the present invention provides a package structure of a sound producing device including a base, a chip, a first mesh and a chamber. The chip is disposed on the base, wherein the chip includes a thin film structure and an actuator configured to actuate the thin film structure to generate a plurality of air pulses, and the chip has an opening corresponding to the thin film structure. The first mesh is disposed on the chip and covering the opening of the chip. The chamber is formed by the base, the chip and the first mesh, wherein the thin film structure is disposed in the chamber. A sound outlet opening is the opening of the chip or the base has the sound outlet opening, and the air pulses propagate outwards through the sound outlet opening.

Due to the present invention, the yield rate, the reliability and the uniformity of the package structure of the sound producing device is enhanced, the adverse impact of the dust and/or the liquid on the component in the package structure is decreased, and the package structure is downsized.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a cross sectional view of a package structure of a sound producing device according to a first embodiment of the present invention.

FIG. 2 is a schematic diagram of a cross sectional view of a chip according to an embodiment of the present invention.

FIG. 3 is a schematic diagram of sound pressure levels of air pulses generated by the chip according to an embodiment of the present invention.

FIG. 4 is a flowchart of a manufacturing method of the package structure of the sound producing device according to an embodiment of the present invention.

FIG. 5 to FIG. 8 are schematic diagrams illustrating structures at different stages of the method for manufacturing the package structure of the sound producing device according to the first embodiment of the present invention.

FIG. 9 is a schematic diagram of a cross sectional view of a package structure of a sound producing device according to a second embodiment of the present invention.

FIG. 10 is a schematic diagram of a cross sectional view of a package structure of a sound producing device according to a third embodiment of the present invention.

FIG. 11 is a schematic diagram of a cross sectional view of a package structure of a sound producing device according to a modification of the third embodiment of the present invention.

FIG. 12 is a schematic diagram of a cross sectional view of a package structure of a sound producing device according to another modification of the third embodiment of the present invention.

FIG. 13 is a schematic diagram of a bottom view of a package structure of a sound producing device according to a fourth embodiment of the present invention.

FIG. 14 is a schematic diagram of a cross sectional view taken along a cross-sectional line A-A′ in FIG. 13.

FIG. 15 is a schematic diagram of a cross sectional view taken along a cross-sectional line B-B′ in FIG. 13.

FIG. 16 is a schematic diagram of a cross sectional view of a package structure of a sound producing device according to a fifth embodiment of the present invention.

FIG. 17 is a schematic diagram of a cross sectional view of a package structure of a sound producing device according to a sixth embodiment of the present invention.

FIG. 18 is a schematic diagram of a cross sectional view of a package structure of a sound producing device according to a seventh embodiment of the present invention.

FIG. 19 is a schematic diagram of a cross sectional view of a package structure of a sound producing device according to an eighth embodiment of the present invention.

FIG. 20 is a schematic diagram of a cross sectional view of a package structure of a sound producing device according to a ninth embodiment of the present invention.

FIG. 21 to FIG. 25 are schematic diagrams illustrating structures at different stages of the method for manufacturing the package structure of the sound producing device according to the ninth embodiment of the present invention.

FIG. 26 is a schematic diagram of a cross sectional view of a package structure of a sound producing device according to a tenth embodiment of the present invention.

FIG. 27 to FIG. 29 are schematic diagrams illustrating structures at different stages of the method for manufacturing the package structure of the sound producing device according to the tenth embodiment of the present invention.

FIG. 30 is a schematic diagram of a cross sectional view of a package structure of a sound producing device according to an eleventh embodiment of the present invention.

### DETAILED DESCRIPTION

To provide a better understanding of the present invention to those skilled in the art, preferred embodiments will be detailed in the follow description. The preferred embodiments of the present invention are illustrated in the accompanying drawings with numbered elements to elaborate on the contents and effects to be achieved. It should be noted that the drawings are simplified schematics, and therefore show only the components and combinations associated with the present invention, so as to provide a clearer description for the basic structure or implementing method of the present invention. The components would be more complex in reality. In addition, for ease of explanation, the components shown in the drawings may not represent their actual number, shape, and dimensions; details may be adjusted according to design requirements.

In the following description and in the claims, the terms “include”, “comprise” and “have” are used in an open-ended fashion, and thus should be interpreted to mean “include, but not limited to . . . ”. Thus, when the terms “include”, “comprise” and/or “have” are used in the description of the present invention, the corresponding features, areas, steps, operations and/or components would be pointed to existence, but not limited to the existence of one or a plurality of the corresponding features, areas, steps, operations and/or components.

When the corresponding component such as layer or area is referred to “on another component (or the variant thereof)” or “extend to another component”, it may be directly on another component or directly extend to another component, or other component may exist between them. On the other hand, when the component is referred to “directly on another component (or the variant thereof)” or “directly extend to another component”, any component does not exist between them. Furthermore, when a component A1 is disposed on a component A2, the component A1 may be situated on upper side, lower side, left side, right side or any other suitable side of the component A2.

It will be understood that when an element or layer is referred to as being “connected to” or “contacted with” another element or layer, it can be directly connected to (or directly contacted with) the other element or layer, or intervening elements or layers may be presented. In contrast, when an element is referred to as being “directly connected to” or “directly contacted with” another element or layer, there are no intervening elements or layers presented.

Although terms such as first, second, third, etc., may be used to describe diverse constituent elements, such constituent elements are not limited by the terms. The terms are used only to discriminate a constituent element from other constituent elements in the specification, and the terms do not relate to the sequence of the manufacture if the specification do not describe. The claims may not use the same terms, but instead may use the terms first, second, third, etc. with respect to the order in which an element is claimed. Accordingly, in the following description, a first constituent element may be a second constituent element in a claim.

It should be noted that the technical features in different embodiments described in the following can be replaced, recombined, or mixed with one another to constitute another embodiment without departing from the spirit of the present invention.

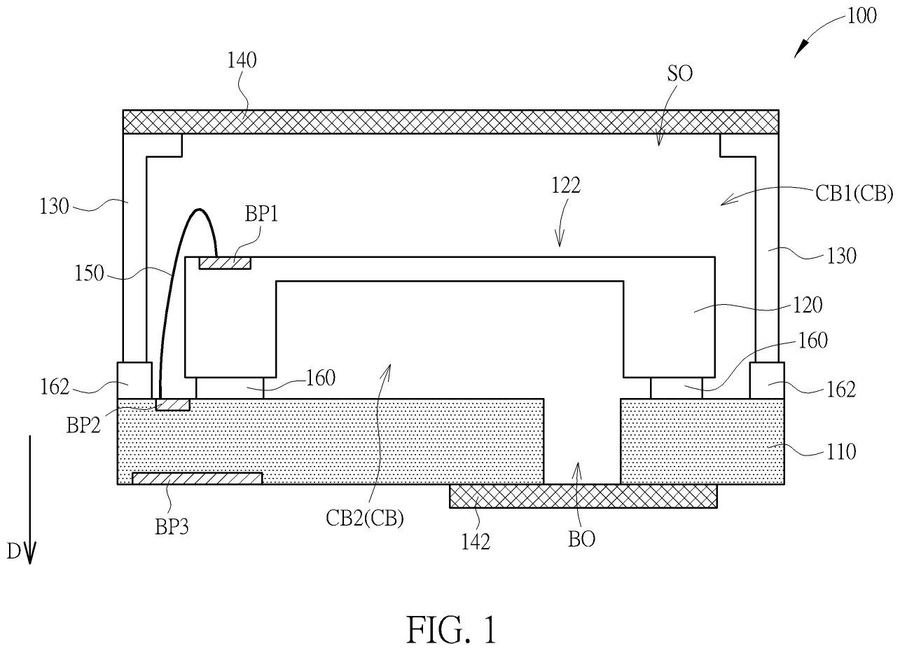

Referring to FIG. 1, FIG. 1 is a schematic diagram of a cross sectional view of a package structure 100 of a sound producing device according to a first embodiment of the present invention. As shown in FIG. 1, the package structure 100 of the sound producing device includes a base 110, a cap 130, a chip 120 and a chamber CB. In some embodiments, the base 110 may be a substrate or an integrated circuit chip. In detail, the substrate served as the base 110 may be a hard substrate or a flexible substrate, wherein the hard substrate may include silicon, germanium, glass, plastic, quartz, sapphire and/or any other suitable material, and the flexible substrate may include plastic, polymer, polyimide (PI), polyethylene terephthalate (PET) and/or other suitable flexible material, but not limited thereto. In some embodiments, the substrate may optionally include conductive material(s), such as metal, to be a laminate substrate, a circuit board, a land grid array (LGA) board or any other suitable substrate/board. The integrated circuit chip may include a circuit having any suitable function. For instance, the integrated circuit chip may be an application-specific integrated circuit (ASIC) chip, but not limited thereto.

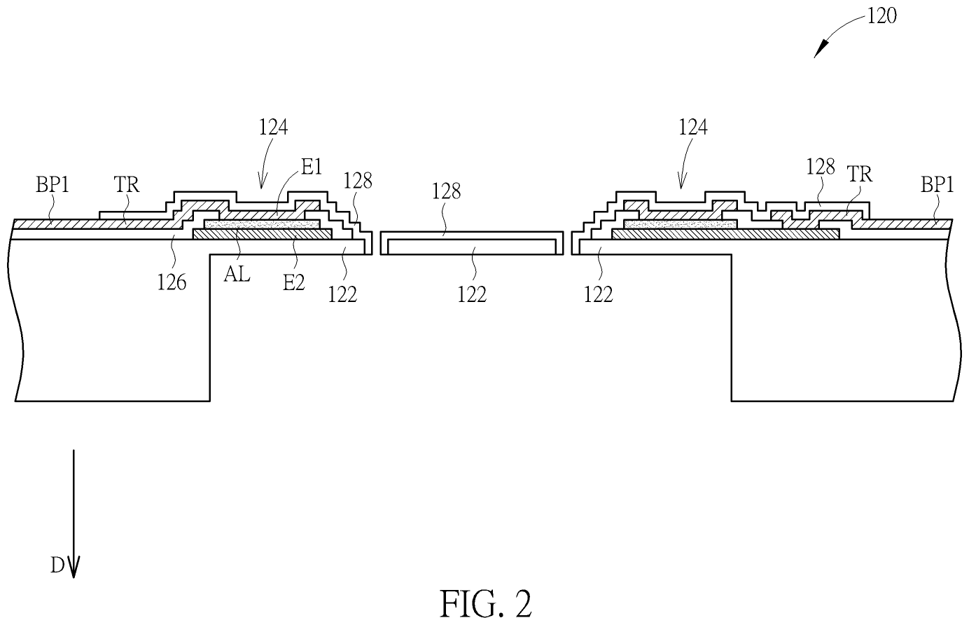

The chip 120 is disposed on the base 110, wherein the chip 120 is configured to generate a plurality of air pulses, so as to produce the sound. In this embodiment, the chip 120 includes a thin film structure 122 configured to be actuated to generate the air pulses. In detail, referring to FIG. 2, FIG. 2 is a schematic diagram of a cross sectional view of a chip according to an embodiment of the present invention, wherein the chip 120 shown in FIG. 2 is an exemplary structure, and the chip 120 may be designed based on requirement(s). As shown in FIG. 2, the chip 120 may include a thin film structure 122 and an actuator 124, and may optionally include at least one first bonding pad BP1, at least one conductive trace and/or any other suitable component. In this embodiment, the actuator 124 may be configured to actuate the thin film structure 122 to generate the air pulses, and the conductive trace TR may be electrically connected between the actuator 124 and the first bonding pad BP1, such that signals may be transmitted to the actuator 124 from an outer device, so as to generate the air pulses. In FIG. 1 and FIG. 2, the upper side of the chip 120 may have the first bonding pad BP1, but not limited thereto. The position of the first bonding pad BP1 may be adjusted based on requirement(s). Furthermore, the chip 120 may optionally include an insulating layer 126 and a protecting film 128, at least a portion of the insulating layer 126 may disposed between two conductive layer (such as two electrodes E1 and E2), and the protecting film 128 may cover at least one structure (such as the thin film structure 122 and/or the actuator 124) for protecting the covered structure(s) (the first bonding pad BP1 may not be covered by the protecting film 128, but not limited thereto). Moreover, in some embodiments, the chip 120 may include any other suitable electronic component, and the conductive trace TR may be electrically connected to this electronic component.

The actuating method of the thin film structure 122 may be adjusted by changing the type of the actuator 124. For example, as shown in FIG. 2, the actuator 124 of this embodiment may include a piezoelectric actuator, the piezoelectric actuator may contain such as two electrodes E1 and E2 and a piezoelectric material layer AL disposed between the electrodes E1 and E2, wherein the piezoelectric material layer AL may actuate the thin film structure 122 based on driving voltages received by the electrodes E1 and E2, but not limited thereto. For example, in another embodiment, the actuator 124 may include an electromagnetic actuator (such as a planar coil), wherein the electromagnetic actuator may actuate the thin film structure 122 based on a received driving current and a magnetic field (i.e. the thin film structure 122 may be actuated by the electromagnetic force). For example, in still another embodiment, the actuator 124 may include an electrostatic actuator (such as conducting plate), wherein the electrostatic actuator may actuate the thin film structure 122 based on a received driving voltage and an electrostatic field (i.e. the thin film structure 122 may be actuated by the electrostatic force). For example, in still another embodiment, the actuator 124 may include an electrothermal actuator (such as a heater), wherein the electrothermal actuator may actuate the thin film structure 122 by the thermal stress or the thermal strain. In still another embodiment, the structure of the chip 120 may be similar to the structure in U.S. application Ser. No. 16/125,761 or the structure in U.S. application Ser. No. 16/380,988 (these are proposed by the same applicant), and these contents are not narrated herein for brevity.

In some embodiments, the chip 120 of the sound producing device produces a sound at the frequency of sound (i.e., the sound producing device generates a sound wave complying with the zero-mean-flow assumption of classic acoustic wave theorems), but not limited thereto.

In some embodiments, instead of producing a sound at the frequency of sound, the chip 120 of the sound producing device generates a series of air pulses at a pulse rate (i.e., the air pulses are generated with a pulse rate), where the pulse rate is higher than a maximum human audible frequency. The air pulse represents a variation in air/sound pressure caused by the sound producing device within a pulse cycle, where the pulse cycle is an inverse/reciprocal of the pulse rate. In other words, the air pulse is in terms of a sound pressure level (SPL). Note that the series/plurality of air pulses may be referred as an ultrasonic pulse array (UPA).

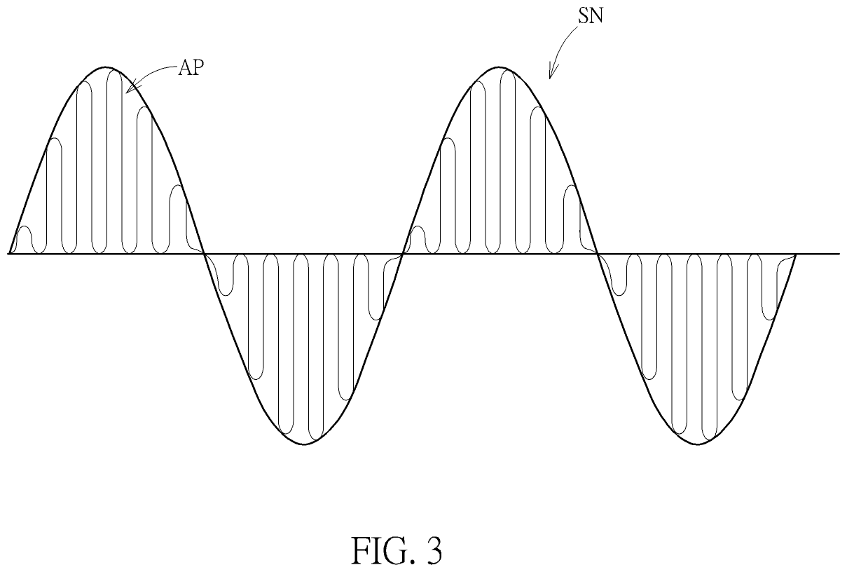

As an example, referring to FIG. 3, FIG. 3 is a schematic diagram of sound pressure levels of air pulses generated by the chip according to an embodiment of the present invention, wherein the sound signal SN shown in coarse line of FIG. 3 is a sinusoidal wave for example, and the air pulses AP are shown in fine line. As shown in FIG. 3, the magnitude of the SPL of each air pulse AP are related to the magnitude of the corresponding time-sample of the sound signal SN, wherein the time-sample of the sound signal SN represents an instantaneous value of the sound signal SN sampled at a sampling time instant. In other words, one wave of the sound signal SN is reproduced by a plurality of air pulses AP. Furthermore, if the lengths of the pulse cycles of the air pulses AP are the same, the number of the air pulses AP reproducing one wave of the sound signal SN is decreased as the audio frequency of the sound signal SN is increased. In some embodiments, in order to make one wave of the sound signal SN be reproduced by the air pulses AP with the sufficient number, the pulse rate of the air pulses AP is higher than the maximum human audible frequency or higher than twice of the maximum human audible frequency (the maximum human audible frequency is generally considered to be 20 KHz), but not limited thereto. Furthermore, in some embodiments, according to Nyquist law, in order to avoid frequency spectral aliasing, the pulse rate needs to be at least twice higher than the maximum frequency of the sound signal SN.

The chip 120 is formed by any suitable manufacturing process. In this embodiment, the chip 120 may be formed by at least one semiconductor process and may include silicon, silicon germanium, silicon carbide, silicon on insulator (SOI), germanium on insulator (GOI), glass, gallium nitride, gallium arsenide, and/or other suitable compound. Note that since the thin film structure 122 of this embodiment is formed by at least one semiconductor process, the chip 120 may be such as a micro electro mechanical system (MEMS), but not limited thereto. Therefore, due to the semiconductor process, the size of the chip 120 (i.e., thickness and/or the lateral dimension) may be decreased. For example, the thickness of the chip 120 may range from 200 μm to 500 μm, but not limited thereto. In another embodiment, the manufacturing process may be similar to the process in U.S. application Ser. No. 16/380,988 (this content is not narrated herein for brevity), but not limited thereto.

As shown in FIG. 1, the cap 130 is disposed on the base 110, and the cap 130 and the chip 120 are on a same side of the base 110. In the view based on the direction D which is perpendicular to a surface of the base 110 (i.e., in top view), the chip 120 is situated on a region inside the cap 130, such that the cap 130 can protect the chip 120. In addition, the cap 130 may include any suitable material, such as metal, glass, silicon, germanium, plastic and/or polymer, but not limited thereto. The cap 130 may be formed by at least one semiconductor process, at least one patterning process, at least one molding process (such as injection molding process), at least one punching process, at least one stamping process, at least one bending process and/or any other suitable process.

The chamber CB is formed inside the cap 130. In detail, the chamber CB is formed by the base 110 and the cap 130 or formed by the base 110, the cap 130 and the chip 120. For instance, in FIG. 1, the chamber CB is formed by the base 110 and the cap 130, but not limited thereto. Moreover, the thin film structure 122 of the chip 120 is disposed in the chamber CB. In FIG. 1, the chamber CB is separated into two portions (a first portion CB1 and a second portion CB2) by the thin film structure 122, wherein the first portion CB1 is situated between the thin film structure 122 and the cap 130, and the second portion CB2 is situated between the thin film structure 122 and the base 110. Note that, the first portion CB1 and the second portion CB2 of the chamber CB may be connected to each other or be completely separated from each other.

In FIG. 1, the chip 120 may be disposed on the base 110 by at least one adhesive component 160, and the cap 130 may be disposed on the base 110 by at least one adhesive component 162. Each of the adhesive components 160 and 162 may individually include an insulating adhesive material and/or a conductive adhesive material; for example, each of the adhesive components 160 and 162 may individually may include glue, epoxy, die attach film (DAF), dry film and/or solder, but not limited thereto. In addition, the material of the adhesive component 160 may be different from or the same as the material of the adhesive component 162.

Moreover, the upper side of the base 110 may have at least one second bonding pad BP2, and the electronic component (e.g., the actuator 124) of the chip 120 may be electrically connected to the second bonding pad BP2, such that the signals may be transmitted to the electronic component (e.g., the actuator 124) from the outer device. In this embodiment, the package structure 100 of the sound producing device may further include at least one conductive component 150, and each conductive component 150 may be electrically connected between the electronic component (e.g., the actuator 124) of the chip 120 and the second bonding pad BP2 of the base 110. The conductive component 150 may be formed by any suitable process and formed at any suitable position. For example, in FIG. 1, the conductive component 150 may be formed by a wire bonding process, and the conductive component 150 may be electrically connected between the first bonding pad BP1 of the chip 120 and the second bonding pad BP2 of the base 110, but not limited thereto. In another embodiment, the chip 120 may be electrically connected to the base 110 through a flip chip package (this will be described in the following embodiment), but not limited thereto. Furthermore, as shown in FIG. 1, since the conductive component 150 electrically connected between the first bonding pad BP1 and the second bonding pad BP2 is formed by the wire bonding process, the material of the adhesive component 160 may only include the insulating adhesive material, but not limited thereto.

In the present invention, one of the base 110 or the cap 130 has a sound outlet opening SO connected to the chamber CB, and the air pulses generated by the thin film structure 122 may propagate outwards through the sound outlet opening SO. As an example, in FIG. 1, the cap 130 may have the sound outlet opening SO connected to the first portion CB1 of the chamber CB, and the sound outlet opening SO may be situated on the upper side of the chip 120 and may face the thin film structure 122 of the chip 120, but not limited thereto. The position of the sound outlet opening SO may be adjusted based on requirement(s).

In particular, in order to reduce the adverse impact of the dust and/or the liquid (such as water) on the chip 120 and other structures of the package structure 100 (such as the conductive component 150), the package structure 100 may optionally include a first mesh 140 covering the sound outlet opening SO, and the first mesh 140 may be on the cap 130. Therefore, the dust and the liquid are hard to enter the package structure 100 through the sound outlet opening SO. In some embodiments, the first mesh 140 may reduce the liquid infiltration due to the design of the surface tension, but the reducing method of the liquid infiltration is not limited thereto. On the other hand, since the first mesh 140 has a plurality of mesh holes (or pores), such that the air pulses may propagate outwards through the sound outlet opening SO and the mesh holes. Furthermore, the first mesh 140 may include any suitable material which is easy to be patterned and/or to be connected to other structure (i.e., the cap 130, the chip 120 or the base 110), such as metal, glass, semiconductor material (e.g., silicon and/or germanium), plastic, fabric, polymer or any combination thereof, but not limited thereto. For example, the first mesh 140 may be made of polyester monofilament fibers, and the polyester monofilament fibers are woven with uniform pore size thereby creating consistent acoustic resistance, wherein the pore size as small as tens micrometer is typical to prevent the penetration of dust and the liquid. Moreover, the first mesh 140 may be formed by any suitable process, such as at least one semiconductor process, at least one patterning process and/or at least one molding process, but not limited thereto.

Optionally, one of the base 110 or the cap 130 may further have a back opening BO connected to the chamber CB and having a plurality of mesh holes. For example, in FIG. 1, the base 110 may have the back opening BO, and the back opening BO is connected to the second portion CB2 of the chamber CB. In some embodiments, the size of the back opening BO is less than the sound outlet opening SO, but not limited thereto. Furthermore, in FIG. 1, in the view based on the direction D (i.e., in top view), the back opening BO may be or may not be situated at the center (for instance, in FIG. 1, the back opening BO may not be situated at the center of the base 110). Moreover, in some embodiments, one of the base 110 or the cap 130 may have the sound outlet opening SO, and another one of the base 110 or the cap 130 may have the back opening BO; in some embodiments, both of the sound outlet opening SO and the back opening BO are included in one of the base 110 or the cap 130, but not limited thereto.

Similarly, in order to reduce the adverse impact of the dust and/or the liquid (such as water) on the chip 120 and other structures of the package structure 100 (such as the conductive component 150), the package structure 100 may optionally include a second mesh 142 covering the back opening BO. For example, in FIG. 1, the second mesh 142 may be on the lower side of the base 110, but not limited thereto. Therefore, the dust and the liquid are hard to enter the package structure 100 through the back opening BO. In some embodiments, the second mesh 142 may reduce the liquid infiltration due to the design of the surface tension, but the reducing method of the liquid infiltration is not limited thereto. Furthermore, the second mesh 142 may include any suitable material which is easy to be patterned and/or to be connected to other structure (i.e., the cap 130, the chip 120 or the base 110), such as metal, glass, semiconductor material (e.g., silicon and/or germanium), plastic, fabric, polymer or any combination thereof, but not limited thereto. In some embodiments, the material of the second mesh 142 may be the same as the first mesh 140, but not limited thereto. Moreover, the second mesh 142 may be formed by any suitable process, such as at least one semiconductor process, at least one patterning process and/or at least one molding process, but not limited thereto.

The package structure 100 of the sound producing device may further include any other required component. For instance, the lower side of the base 110 may have at least one third bonding pad BP3, wherein the third bonding pad BP3 may be connected to the outer device (such as an outer signal source) through an outer-conductive component, but not limited thereto. In this embodiment, the third bonding pad BP3 may be electrically connected to the second bonding pad BP2 through such as at least one trace in the base 110, such that the actuator 124 of the chip 120 may receive the signal from the outer device.

For another instance, in some embodiments, the package structure 100 may further include a protecting structure covering the conductive component 150. Thus, the conductive component 150 may be protected by the protecting structure. For example, the conductive component 150 may include epoxy and/or any other suitable material.

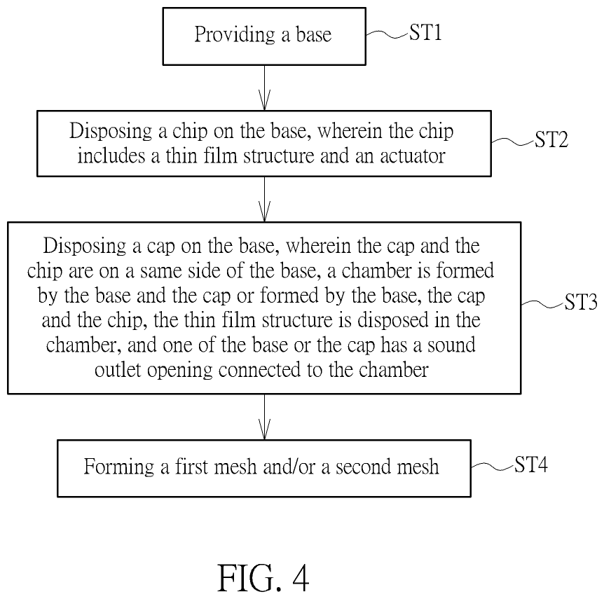

Referring to FIG. 4, FIG. 4 is a flowchart of a manufacturing method of the package structure of the sound producing device according to an embodiment of the present invention. It is to be appreciated that the flowchart shown in FIG. 4 is exemplary. In some embodiments, some of the steps may be performed simultaneously, or in a different order than shown in FIG. 4. In some embodiments, before or after one of the existing step of the manufacturing method shown in FIG. 4, any other suitable step may be added. Regarding the following contents, the manufacturing method shall be described with reference to FIG. 4. However, the manufacturing method is not limited to those example embodiments.

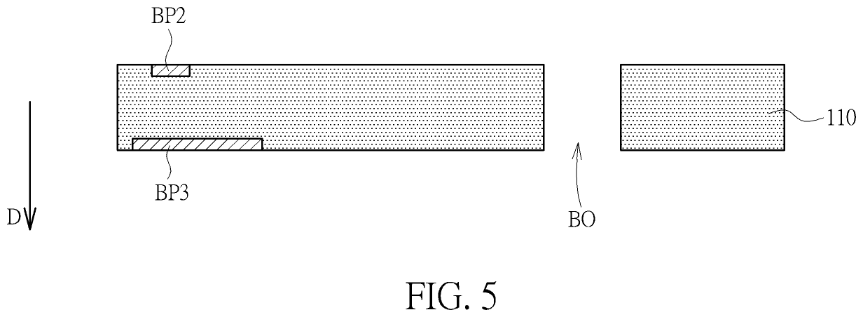

In order to explain the manufacturing method more clearly, FIG. 5 to FIG. 8 and FIG. 1 are further referred, wherein FIG. 5 to FIG. 8 are schematic diagrams illustrating structures at different stages of the method for manufacturing the package structure of the sound producing device according to the first embodiment of the present invention, and FIG. 1 shows the package structure 100 of the sound producing device according to the first embodiment of the present invention after the manufacturing method is accomplished.

In step ST1 of FIG. 4, the base 110 is provided (as shown in FIG. 5). Note that the material, structure and type of the base 110 can be referred to in any suitable embodiment of the present invention, and these will not be redundantly described.

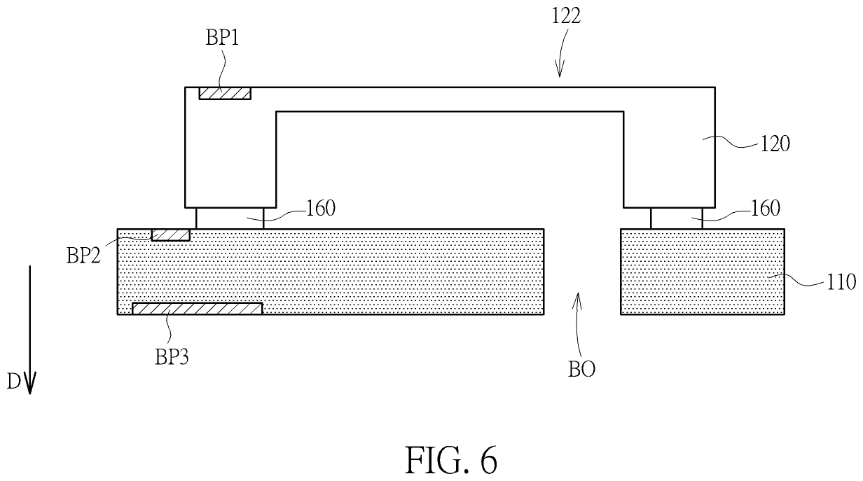

In step ST2 of FIG. 4, the chip 120 at least including the thin film structure 122 and the actuator 124 is disposed on the base 110 (as shown in FIG. 6). In FIG. 6, the chip 120 may be disposed on the base 110 by the adhesive component(s) 160. Note that the material, structure and type of the chip 120 and the material of the adhesive component(s) 160 can be referred to in any suitable embodiment of the present invention, and these will not be redundantly described.

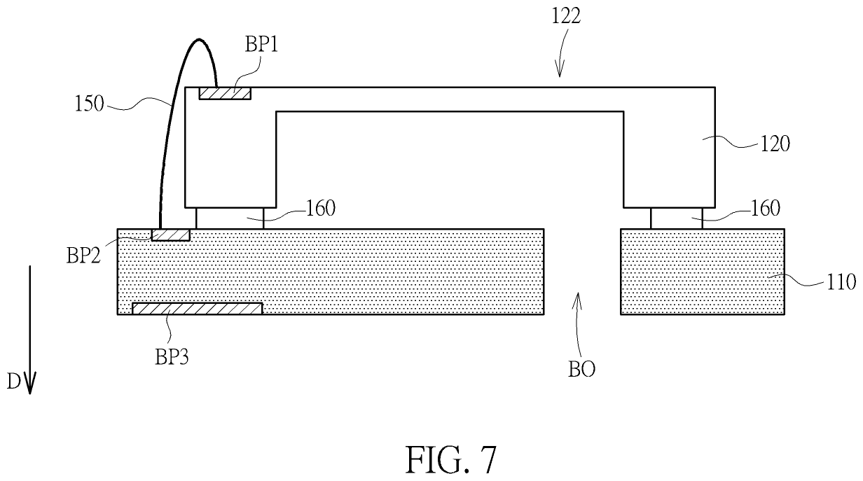

In this embodiment, as shown in FIG. 7, after step ST2, the conductive component 150 electrically connected between the actuator 124 of the chip 120 and the base 110 is formed. The conductive component 150 may be formed by any suitable process and formed at any suitable position. In this embodiment, the conductive component 150 may be electrically connected between the first bonding pad BP1 of the chip 120 and the second bonding pad BP2 of the base 110, and the conductive component 150 may be formed by a wire bonding process, but not limited thereto. Note that other content of the conductive component 150 can be referred to in any suitable embodiment of the present invention, and this will not be redundantly described.

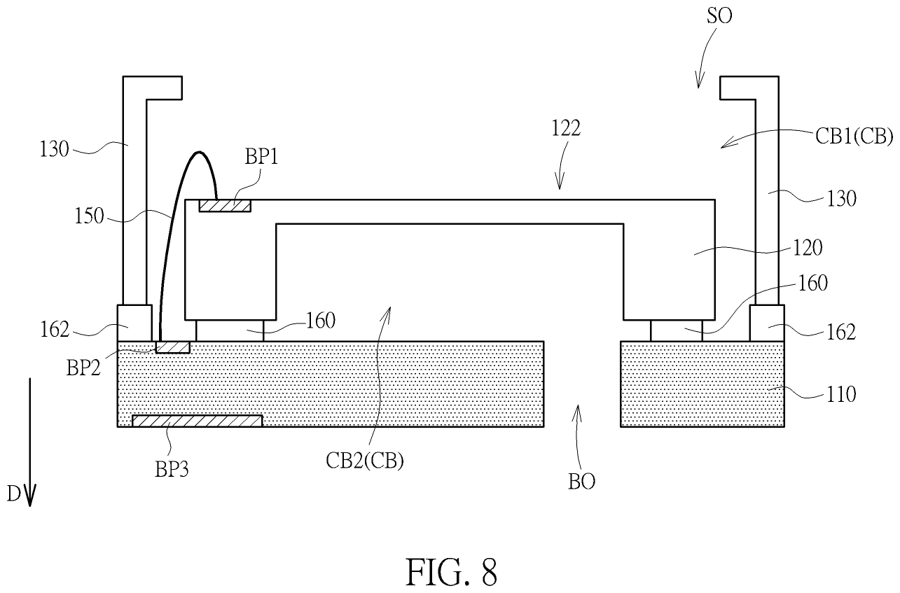

In step ST3 of FIG. 4, the cap 130 is disposed on the base 110. In this embodiment, the cap 130 may be disposed on the base 110 by the adhesive component(s) 162 (as shown in FIG. 8). Note that the material, structure and type of the cap 130 can be referred to in any suitable embodiment of the present invention, and these will not be redundantly described.

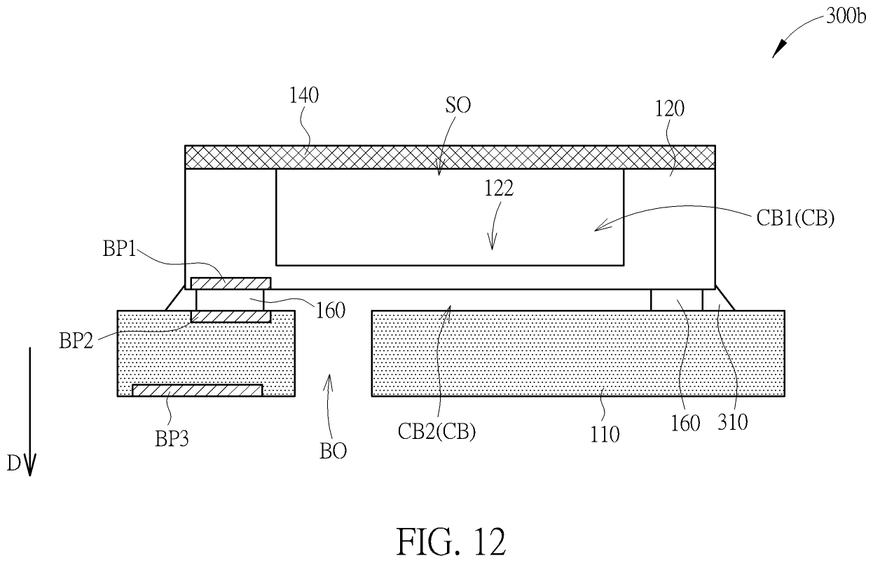

Moreover, in some embodiments (such as an embodiment shown in FIG. 12), the cap 130 is not included in the package structure, but not limited thereto. Note that this embodiment will be explained when introducing FIG. 12.

Optionally, in step ST4 of FIG. 4, the first mesh 140 covering the sound outlet opening SO is formed (as shown in FIG. 1). Optionally, in the step ST4 in FIG. 4, the second mesh 142 covering the back opening BO is formed (as shown in FIG. 1). Note that the materials, structures and types of the first mesh 140 and the second mesh 142 can be referred to in any suitable embodiment of the present invention, and these will not be redundantly described.

Due to the design of the package structure 100 of the sound producing device, the component in the package structure 100 (such as the chip 120, the conductive component 150 and/or any other component) may be protected, so as to enhance the yield rate and the reliability. More particularly, the unintended physical and chemical damages on the conductive component 150 and the chip 120 may be reduced when the package structure 100 of the sound producing device is employed or when the package structure 100 of the sound producing device is assembled in a product. Furthermore, the adverse impact of the dust and/or the liquid on the component in the package structure 100 is decreased. On the other hand, in this embodiment, since the chip 120 is formed of the semiconductor process, and the package structure 100 of the sound producing device may be formed of a semiconductor packaging process, the package structure 100 may be downsized (the lateral dimension of the package structure 100 may be smaller than or equal to, but not limited to, 10 mm×10 mm or 5 mm×5 mm) and the uniformity of the package structure 100 may be enhanced. Moreover, if at least one integrated circuit chip exists in this package structure 100, and one integrated circuit chip is served as the base 110, the package structure 100 may be downsized more.

The package structure of the sound producing device and the manufacturing method of the package structure of the sound producing device of the present invention are not limited to the above embodiments. Further embodiments of the present invention are described below. For ease of comparison, same components will be labeled with the same symbol in the following. The following descriptions relate the differences between each of the embodiments, and repeated parts will not be redundantly described.

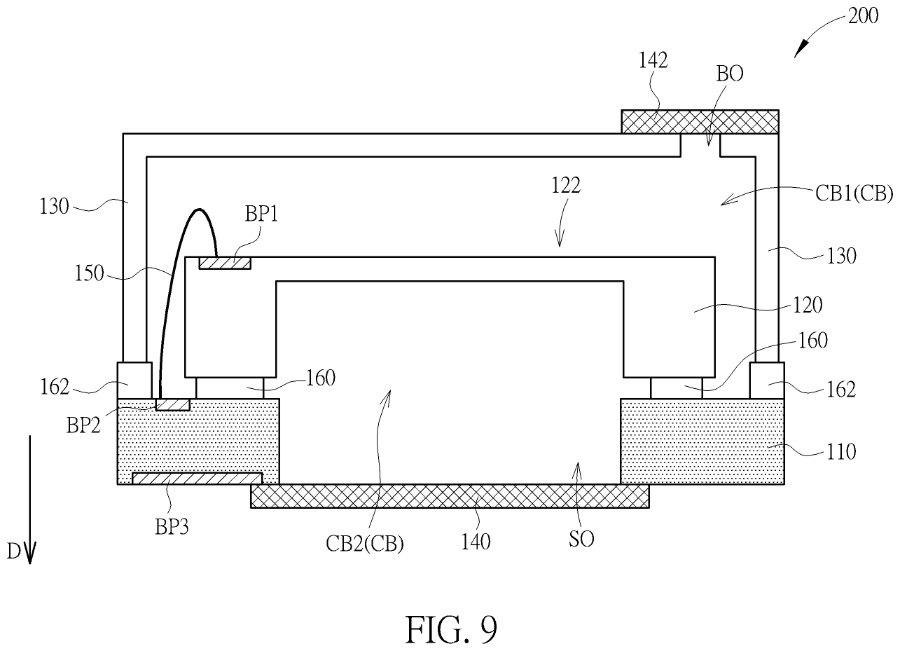

Referring to FIG. 9, FIG. 9 is a schematic diagram of a cross sectional view of a package structure of a sound producing device according to a second embodiment of the present invention. As shown in FIG. 9, a difference between this embodiment and the first embodiment is the positions of the sound outlet opening SO and the back opening BO. In the package structure 200 of the sound producing device shown FIG. 9, the base 110 has the sound outlet opening SO connected to the second portion CB2 of the chamber CB, and the cap 130 has the back opening BO connected to the first portion CB1 of the chamber CB, wherein the back opening BO may be situated on the upper side of the chip 120 and may face the thin film structure 122 of the chip 120, but not limited thereto. Correspondingly, the first mesh 140 may be on the lower side of the base 110 for covering the sound outlet opening SO, and the second mesh 142 may be on the cap 130 for covering the back opening BO, but not limited thereto.

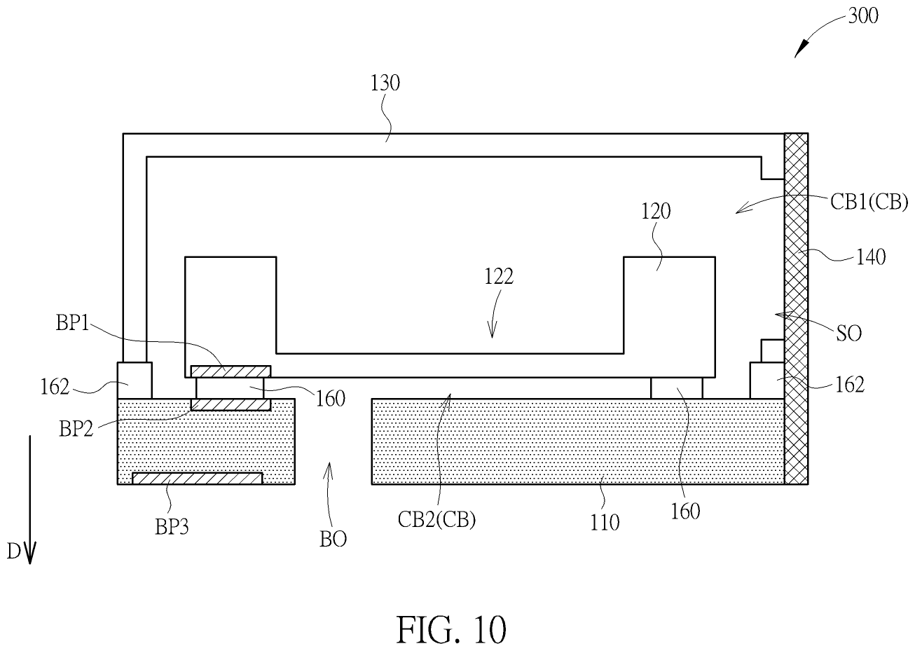

Referring to FIG. 10, FIG. 10 is a schematic diagram of a cross sectional view of a package structure of a sound producing device according to a third embodiment of the present invention. As shown in FIG. 10, a difference between this embodiment and the first embodiment is the positions of the sound outlet opening SO and the back opening BO. In the package structure 300 of the sound producing device shown in FIG. 10, the sound outlet opening SO may be situated on the lateral side of the chip 120, but not limited thereto. In addition, another difference between this embodiment and the first embodiment is that the chip 120 of the package structure 300 of this embodiment may be electrically connected to the base 110 through a flip chip package. Compared with the first embodiment, the chip 120 of this embodiment may be disposed upside down, and the adhesive component 160 may be disposed between the first bonding pad BP1 of the chip 120 and the second bonding pad BP2 of the base 110 and may include the conductive adhesive material (such as, but not limited to, solder), such that the adhesive component 160 may be served as the conductive component, and the first bonding pad BP1 may be electrically connected to the second bonding pad BP2 through the adhesive component 160.

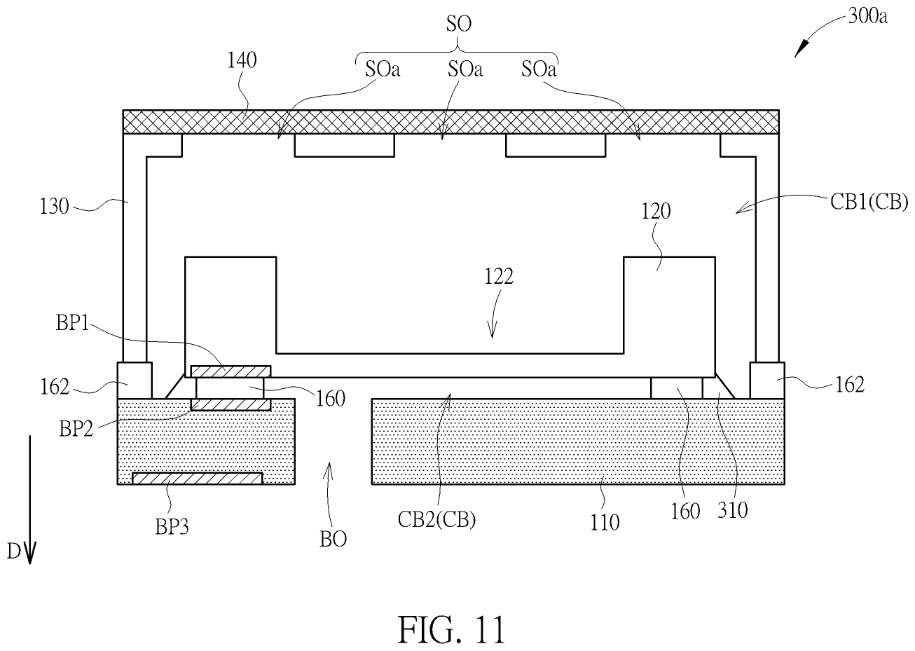

Referring to FIG. 11, FIG. 11 is a schematic diagram of a cross sectional view of a package structure of a sound producing device according to a modification of the third embodiment of the present invention. As shown in FIG. 11, a difference between this embodiment and the third embodiment shown in FIG. 10 is the design of the sound outlet opening SO. In the package structure 300a, the sound outlet opening SO may be situated on the upper side of the chip 120, but not limited thereto. Optionally, in FIG. 10, the sound outlet opening SO may include a plurality of sub-openings SOa. For example, the sound outlet opening SO shown in FIG. 10 has three sub-openings SOa, but not limited thereto. Moreover, optionally, the package structure 300a may further include an underfill layer 310 disposed between the chip 120 and the base 110, so as to protect the adhesive component 160 served as the conductive component.

Referring to FIG. 12, FIG. 12 is a schematic diagram of a cross sectional view of a package structure of a sound producing device according to another modification of the third embodiment of the present invention. As shown in FIG. 12, a difference between this embodiment and the embodiment shown in FIG. 11 is that the package structure 300b may not include the cap, and the first mesh 140 is attached to the upper side of the chip 120. Thus, in this embodiment, the chamber CB is formed by the base 110, the chip 120 and the first mesh 140, wherein the first portion CB1 is situated between the thin film structure 122 and the first mesh 140, and the second portion CB2 is situated between the thin film structure 122 and the base 110. Furthermore, since the chip 120 is electrically connected to the base 110 through the flip chip package, the first mesh 140 in FIG. 12 may be attached to the backside of the chip 120. Moreover, the sound outlet opening SO of this embodiment is determined by the upper side of the chip 120 (i.e., the sound outlet opening SO is an opening of the chip 120 corresponding to the thin film structure 122), but not limited thereto. In another embodiment, the base 110 has the sound outlet opening SO, and the back opening BO is determined by the upper side of the chip 120, but not limited thereto.

In this embodiment, since the cap is eliminated, the dimension of the package structure 300b may be decreased, and the degradation of the sound quality due to an additional acoustic resonance caused by the cap may be prevented.

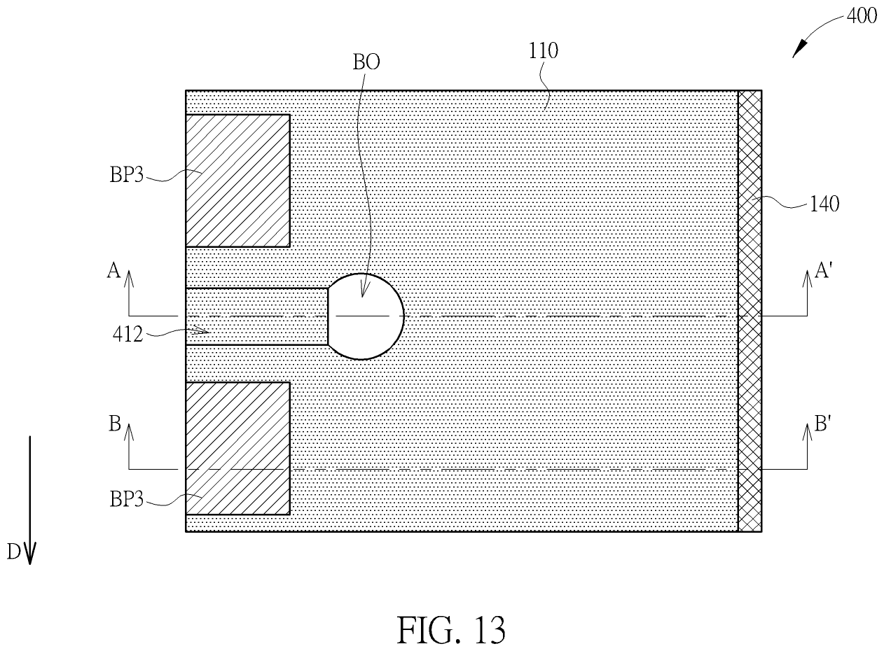

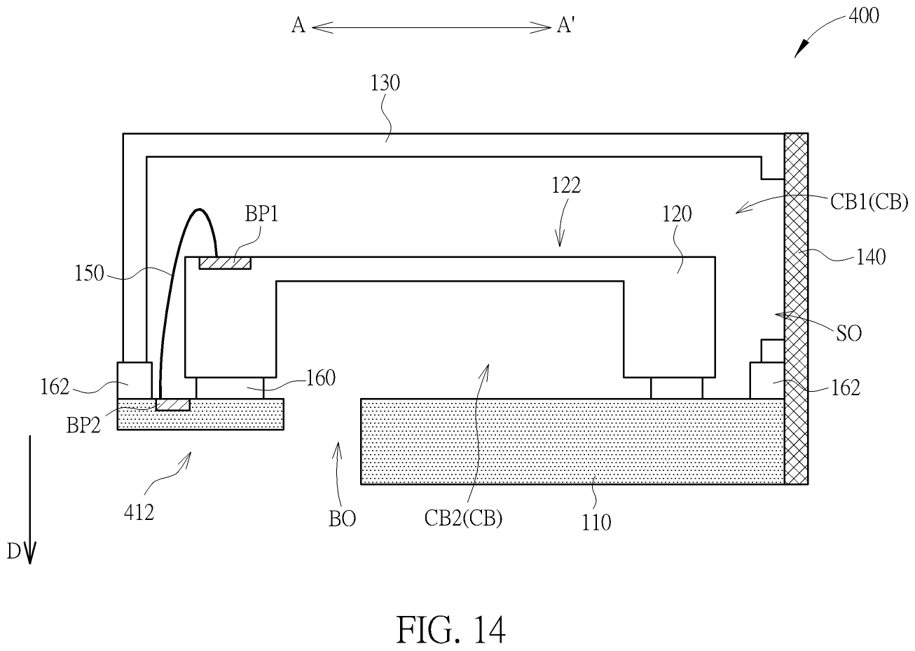

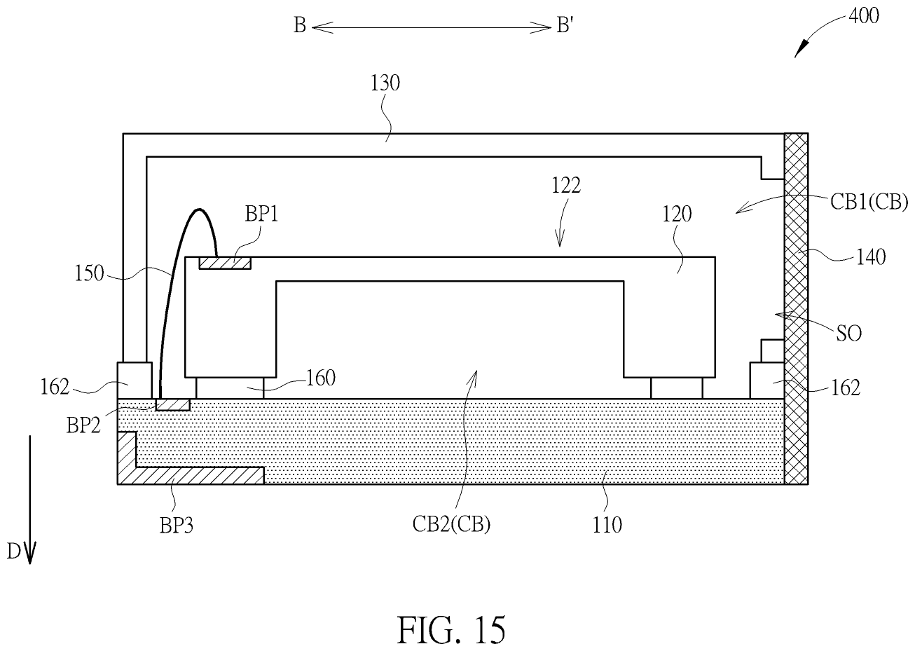

Referring to FIG. 13 to FIG. 15, FIG. 13 is a schematic diagram of a bottom view of a package structure of a sound producing device according to a fourth embodiment of the present invention, FIG. 14 is a schematic diagram of a cross sectional view taken along a cross-sectional line A-A′ in FIG. 13, and FIG. 15 is a schematic diagram of a cross sectional view taken along a cross-sectional line B-B′ in FIG. 13. As shown in FIG. 13 to FIG. 15, a difference between this embodiment and the first embodiment is the designs of the sound outlet opening SO and the back opening BO. In the package structure 400 of the sound producing device shown in FIG. 13 to FIG. 15, the sound outlet opening SO may be situated on the lateral side of the chip 120, but not limited thereto. Furthermore, in this embodiment, the base 110 may further have a hollow portion 412 including two ends, one of the ends of the hollow portion 412 may be connected to the back opening BO, and another one of the ends of the hollow portion 412 may extend to a sidewall of the base 110, but not limited thereto. Thus, in FIG. 14, the second portion CB2 of the chamber CB may be connected to the outside of the package structure 400 through the lower side or the lateral side of the base 110. Optionally, the lower side and the lateral side of the base 110 may have at least one third bonding pad BP3. For example, as shown in FIG. 15, the third bonding pad BP3 may include an L-shape structure disposed on both of the lower side and the lateral side, but not limited thereto.

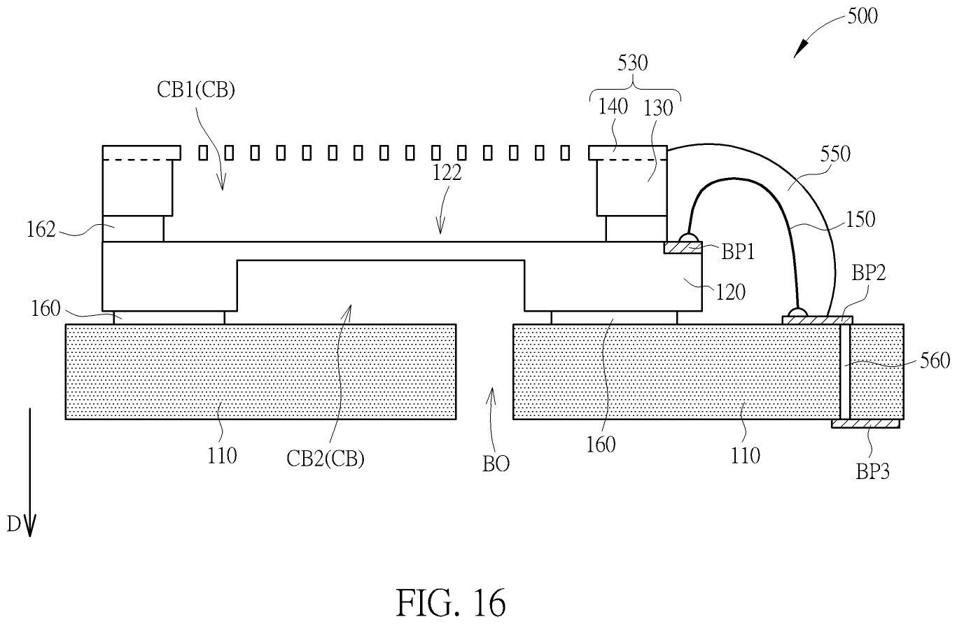

Referring to FIG. 16, FIG. 16 is a schematic diagram of a cross sectional view of a package structure of a sound producing device according to a fifth embodiment of the present invention. As shown in FIG. 16, a difference between this embodiment and the first embodiment is the design of cap 130 and the first mesh 140. In the package structure 500 of the sound producing device shown in FIG. 16, the cap 130 may be disposed on the chip 120 by the adhesive component 162, such that the size of the package structure 500 may be reduced more. Moreover, in FIG. 16, the cap 130 and the first mesh 140 may be integrated in a cap chip 530 formed by at least one semiconductor process and/or at least one patterning process, wherein the mesh holes of the first mesh 140 may be formed by such as a wet etching process, a dry etch process, a laser etching process or a combination thereof. Furthermore, in this embodiment, although the back opening BO is included in the package structure 500, but the package structure 500 may not include the second mesh 142, but not limited thereto. In addition, in FIG. 16, the package structure 500 may further include a protecting structure 550 covering the conductive component 150 for protecting the conductive component 150, but not limited thereto.

Since the cap 130 and the first mesh 140 of this embodiment are integrated in the cap chip 530 formed by the semiconductor process and/or the patterning process, the package structure 500 may be downsized more. More precisely, the thickness of the cap chip 530 may range from 200 μm to 300 μm, and the adhesive component 162 (such as the dry film) may range from 10 μm to 20 μm. Therefore, the total thickness of the chip 120 and the cap chip 530 may be less than 600 μm, but not limited thereto.

In addition, in FIG. 16, the chamber CB may be formed by the base 110, the cap 130 and the chip 120, but not limited thereto. Moreover, in this embodiment, the third bonding pad BP3 is electrically connected to the second bonding pad BP2 by the trace 560 in a through hole of the base 110, wherein the through hole is formed by a through silicon via (TSV) process or any other suitable process.

In some embodiments, the package structure 500 may optionally include a circuit board disposed on the base 110, and the circuit board may be electrically connected to the chip 120 (such as the actuator 124). In one case, the circuit board may be disposed on the lower side of the base 110 and may be electrically connected to the third bonding pad BP3 through a conductive material, but not limited thereto. In one case, the circuit board may be disposed on the upper side of the base 110 and may be electrically connected to the second bonding pad BP2 through a conductive material, but not limited thereto. In one case, the circuit board may be disposed on the upper side of the base 110 and may be electrically connected to the chip 120 through the conductive component 150 (i.e., the conductive component 150 is connected between the first bonding pad BP1 of the chip 120 and the circuit board), but not limited thereto.

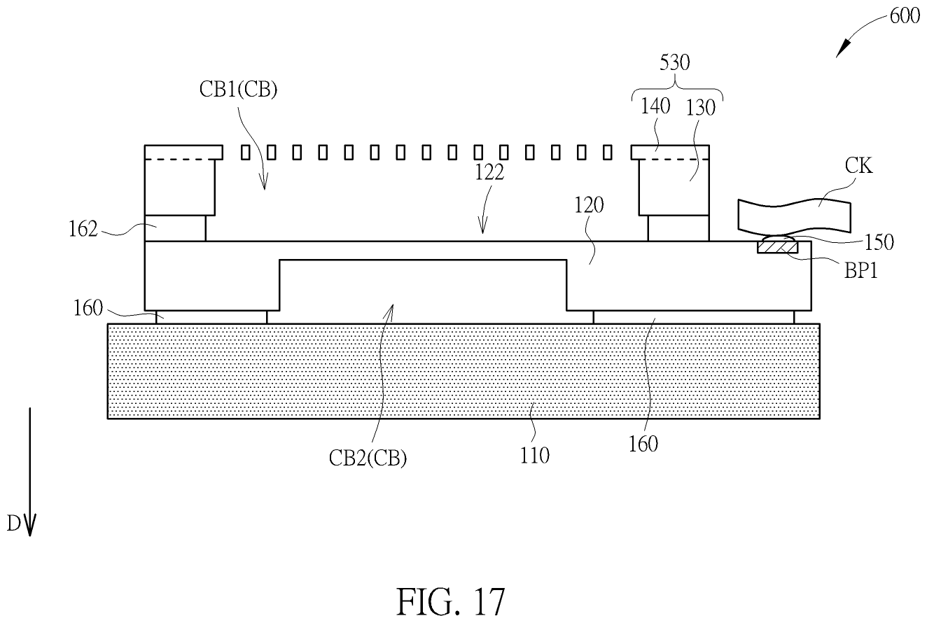

Referring to FIG. 17, FIG. 17 is a schematic diagram of a cross sectional view of a package structure of a sound producing device according to a sixth embodiment of the present invention. As shown in FIG. 17, compared with the fifth embodiment, the circuit board CK is further included in the package structure 600 and disposed on the chip 120. In this embodiment, the conductive component 150 may be disposed between the circuit board CK and the chip 120 for their electrical connection, but not limited thereto. In another embodiment, the conductive component 150 may be connected between the circuit board CK and the chip 120 by a wire bonding process, but not limited thereto. In addition, as an example, in FIG. 17, the back opening BO and the second mesh 142 are not included in the package structure 600, but not limited thereto. The back opening BO and the second mesh 142 are optionally included in the package structure.

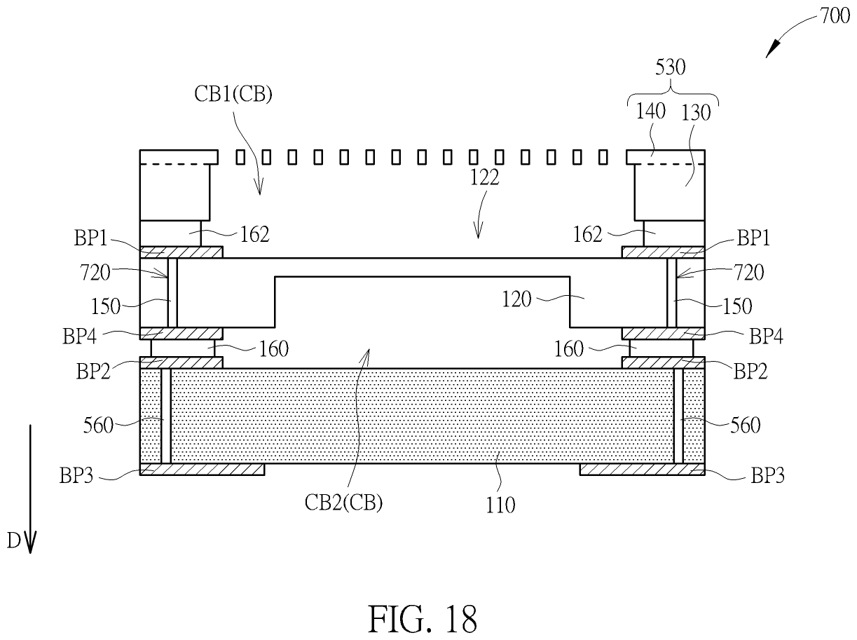

Referring to FIG. 18, FIG. 18 is a schematic diagram of a cross sectional view of a package structure of a sound producing device according to a seventh embodiment of the present invention. As shown in FIG. 18, compared with the fifth embodiment, the chip 120 may further include a hole 720 passing through the chip 120, and the conductive component 150 is disposed in the hole 720 of the chip 120, such that the first bonding pad BP1 is electrically connected to the second bonding pad BP2 by the conductive component 150 disposed in the chip 120. In this embodiment, in the package structure 700, the hole 720 is formed by a through silicon via (TSV) process or any other suitable process. Furthermore, in this embodiment, the adhesive component 160 disposed between the chip 120 and the base 110 may include the conductive adhesive material, and the adhesive component 160 electrically connected to the conductive component 150 through a fourth bonding pad BP4 the chip 120 (the lower side of the chip 120 has the fourth bonding pad BP4), but not limited thereto. Note that, in this embodiment, the design of the electrical connection in the package structure 700 makes the lateral dimension of the package structure 700 be downsized.

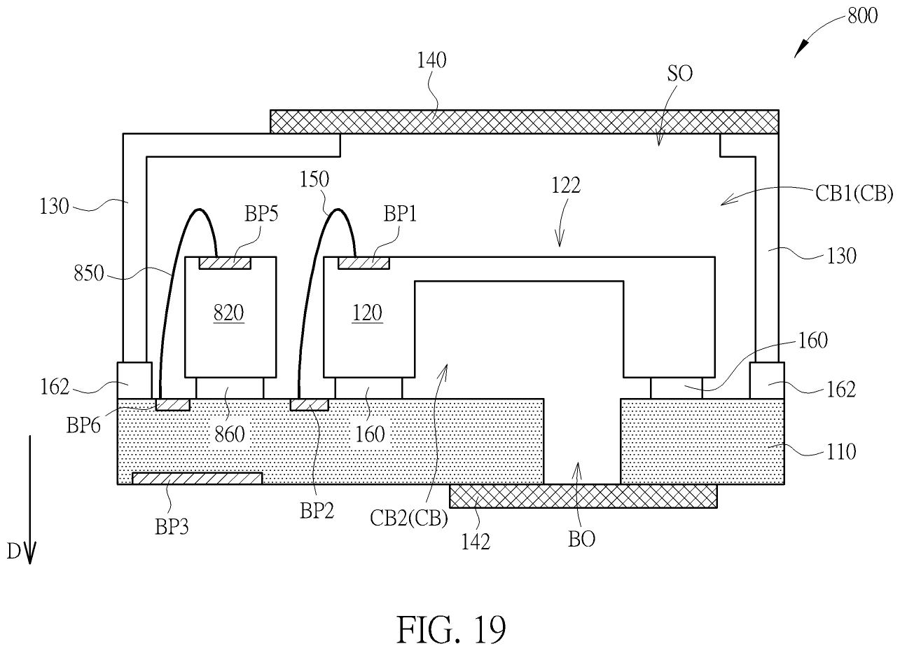

Referring to FIG. 19, FIG. 19 is a schematic diagram of a cross sectional view of a package structure of a sound producing device according to an eighth embodiment of the present invention. As shown in FIG. 19, a difference between this embodiment and the first embodiment is that an integrated circuit chip is further included in the package structure 800, wherein the integrated circuit chip 820 is disposed on the base 110. In FIG. 19, the integrated circuit chip 820, the chip 120 and the cap 130 are on a same side of the base 110, the integrated circuit chip 820 is situated on a region inside the cap 130 in the view based on the direction D (i.e., in top view), and the integrated circuit chip 820 does not overlap the chip 120 in the direction D, but not limited thereto. In some embodiments, if the base 110 is also an integrated circuit chip, two integrated circuit chips may be stacked. In addition, an adhesive component 860 is further included to adhere the integrated circuit chip 820 and the base 110, wherein the material of the adhesive component 860 may include an insulating adhesive material and/or a conductive adhesive material, such as glue, epoxy, die attach film (DAF), dry film and/or solder, but not limited thereto. In this embodiment, as shown in FIG. 19, the integrated circuit chip 820 may be electrically connected to the base 110 through another conductive component 850 (the conductive component 850 is connected between a fifth bonding pad BP5 of the integrated circuit chip 820 and a sixth bonding pad BP6 of the base 110), and the material of the adhesive component 860 may include an insulating adhesive material, but not limited thereto.

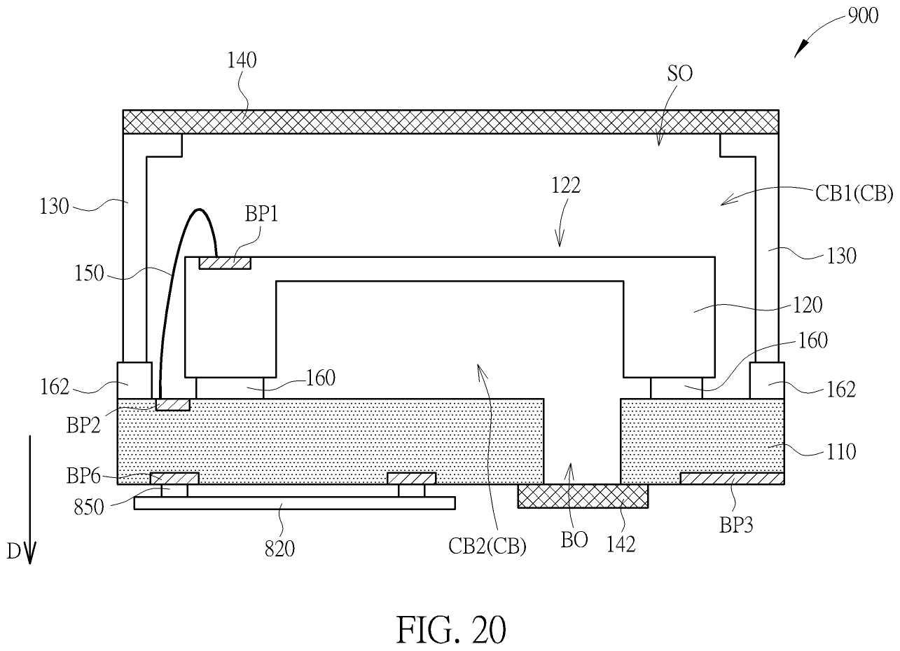

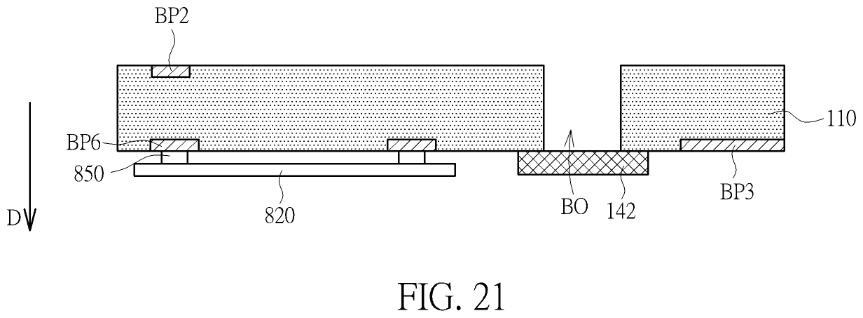

Referring to FIG. 20 to FIG. 25, FIG. 20 is a schematic diagram of a cross sectional view of a package structure of a sound producing device according to a ninth embodiment of the present invention, and FIG. 21 to FIG. 25 are schematic diagrams illustrating structures at different stages of the method for manufacturing the package structure of the sound producing device according to the ninth embodiment of the present invention. As shown in FIG. 20, compared with the eighth embodiment, in the package structure 900, the integrated circuit chip 820 and the chip 120 may be on different sides of the base 110. Therefore, the lateral dimension of the package structure 900 may be downsized due to the overlap of the chip 120 (or other component) and the integrated circuit chip 820. Furthermore, in this embodiment, the integrated circuit chip 820 may be electrically connected to the base 110 through the conductive component 850 disposed between the integrated circuit chip 820 and the base 110 and having an adhesive function.

As shown in FIG. 4 and FIG. 20 to FIG. 25, the manufacturing method of the package structure 900 of the sound producing device of this embodiment is shown. In the step ST1 of FIG. 4, the base 110 is provided (as shown in FIG. 21). Note that the material, structure and type of the base 110 can be referred to in any suitable embodiment of the present invention, and these will not be redundantly described. Then, in FIG. 21, the integrated circuit chip 820 and the conductive component 850 are disposed on the lower side of the base 110. Optionally, in FIG. 21, the second mesh 142 may be further disposed on the lower side of the base 110.

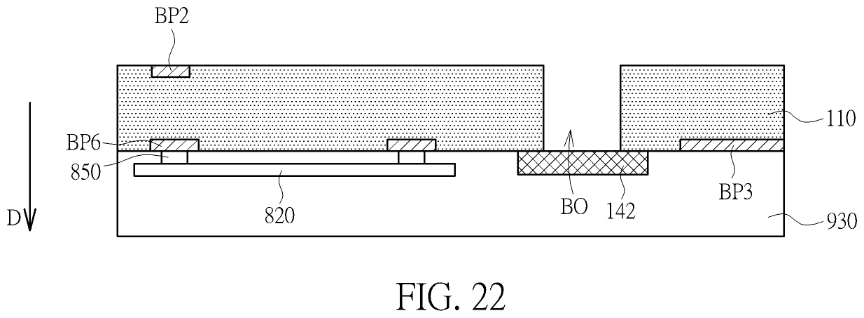

In FIG. 22, the manufacturing method may further include a step, and this step forms a protecting layer 930 on the base 110 to cover the integrated circuit chip 820. The protecting layer 930 is configured to protect the component(s) (such as the base 110 and/or the mesh) disposed on the lower side of the base 110, so as to reduce the damage on the component(s) due to the subsequent manufacturing step(s). In addition, the protecting layer 930 may further provide a flat lower surface, so as to advantage the subsequent manufacturing step(s).

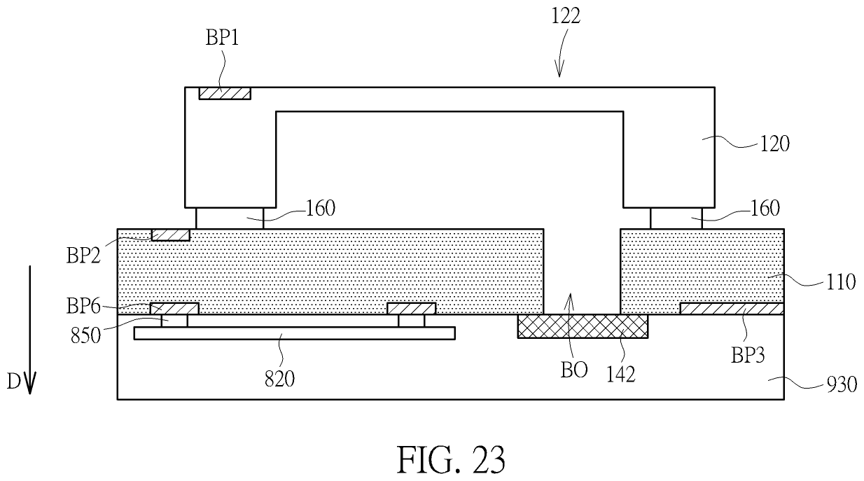

In step ST2 of FIG. 4, the chip 120 at least including the thin film structure 122 and the actuator 124 is disposed on the base 110 (as shown in FIG. 23). In FIG. 23, the chip 120 is disposed on the upper side of the base 110. Note that the material, structure and type of the chip 120 and the material of the adhesive component(s) 160 can be referred to in any suitable embodiment of the present invention, and these will not be redundantly described. Note that, as shown in FIG. 21 to FIG. 23, the step of disposing the integrated circuit chip 820 on the base 110 is performed before disposing the chip 120 on the base 110 and disposing the cap 130 on the base 110, and the step of forming the protecting layer 930 is performed after disposing the integrated circuit chip 820 on the base 110 and before disposing the chip 120 on the base 110 and disposing the cap 130 on the base 110.

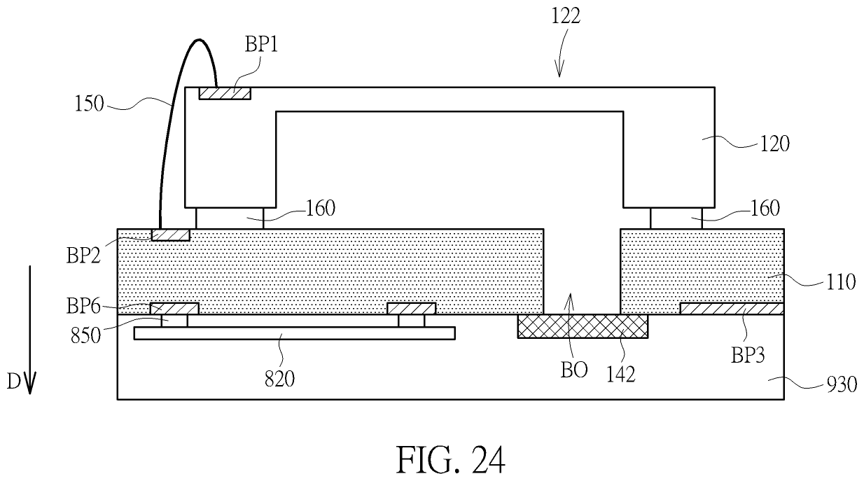

In this embodiment, as shown in FIG. 24, the conductive component 150 electrically connected between the actuator 124 of the chip 120 and the base 110 is formed. Note that other content of the conductive component 150 can be referred to in any suitable embodiment of the present invention. For example, the chip 120 may be electrically connected to the base 110 through a flip chip package, and the adhesive component 160 may be served as the conductive component.

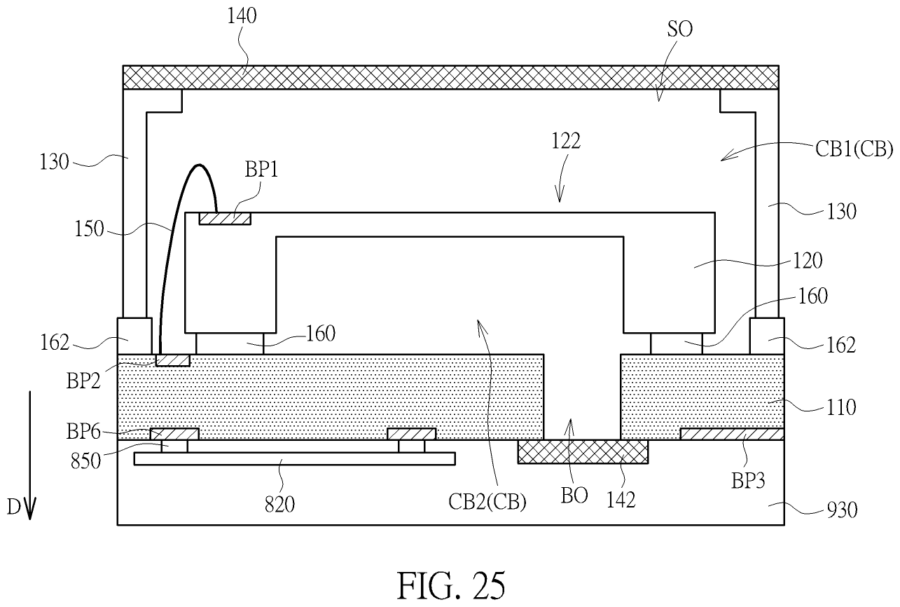

Then, in steps ST3 and ST4 of FIG. 4, the cap 130 is disposed on the base 110, and the first mesh 140 covering the sound outlet opening SO is formed (as shown in FIG. 25). Note that the material, structure and type of the cap 130 can be referred to in any suitable embodiment of the present invention, the materials, structures and types of the first mesh 140 and the second mesh 142 can be referred to in any suitable embodiment of the present invention, and these will not be redundantly described. Next, the protecting layer 930 is removed, such that the manufacture of the package structure 900 shown in FIG. 20 is completed.

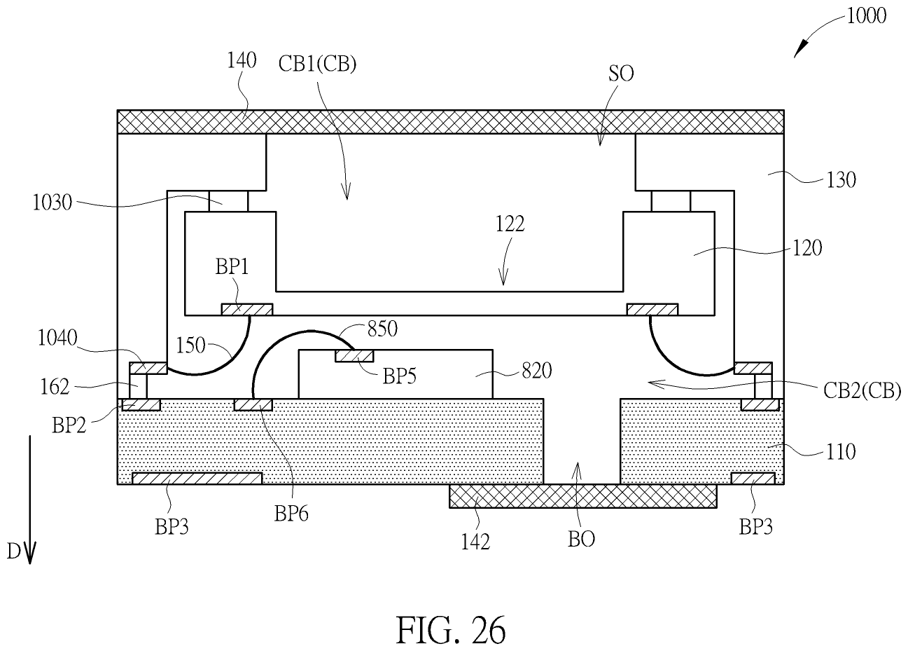

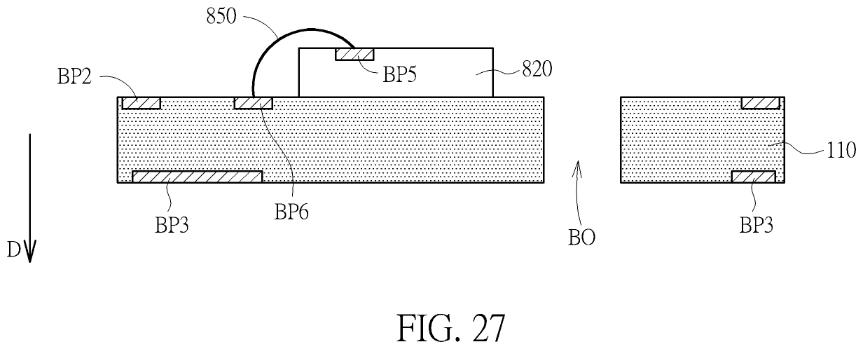

Referring to FIG. 26 to FIG. 29, FIG. 26 is a schematic diagram of a cross sectional view of a package structure of a sound producing device according to a tenth embodiment of the present invention, and FIG. 27 to FIG. 29 are schematic diagrams illustrating structures at different stages of the method for manufacturing the package structure of the sound producing device according to the tenth embodiment of the present invention. As shown in FIG. 26, compared with the eighth embodiment, in the package structure 1000, the chip 120 may be connected to the cap 130 through a connecting component 1030, wherein the connecting component 1030 may include an insulating material and/or a conductive material; for instance, the connecting component 1030 may include glue, epoxy, die attach film (DAF), dry film and/or solder, but not limited thereto. In addition, in FIG. 26, the conductive component 150 is electrically connected to the first bonding pad BP1 of the chip 120 and a conductive structure 1040 of the cap 130, such that the chip 120 may be electrically connected to the base 110 through the first bonding pad BP1 of the chip 120, the conductive component 150, the conductive structure 1040 of the cap 130, the adhesive component 162 and the second bonding pad BP2 of the base 110, but not limited thereto. Note that the conductive structure 1040 of the cap 130 may be designed to any other suitable type based on requirement(s). In another embodiment, the chip 120 may be electrically connected to the cap 130 through the connecting component 1030 (having a function similar to the conductive component 150), such that the chip 120 may be electrically connected to the base 110 through the first bonding pad BP1 of the chip 120, the conductive structure 1040 of the cap 130 (such as, the trace in the cap 130), the adhesive component 162 and the second bonding pad BP2 of the base 110, but not limited thereto.

As shown in FIG. 4 and FIG. 26 to FIG. 29, the manufacturing method of the package structure 1000 of the sound producing device of this embodiment is shown. In step ST1 of FIG. 4, the base 110 is provided (as shown in FIG. 27). Note that the material, structure and type of the base 110 can be referred to in any suitable embodiment of the present invention, and these will not be redundantly described. Then, in FIG. 27, the integrated circuit chip 820 and the conductive component 850 are disposed on the base 110.

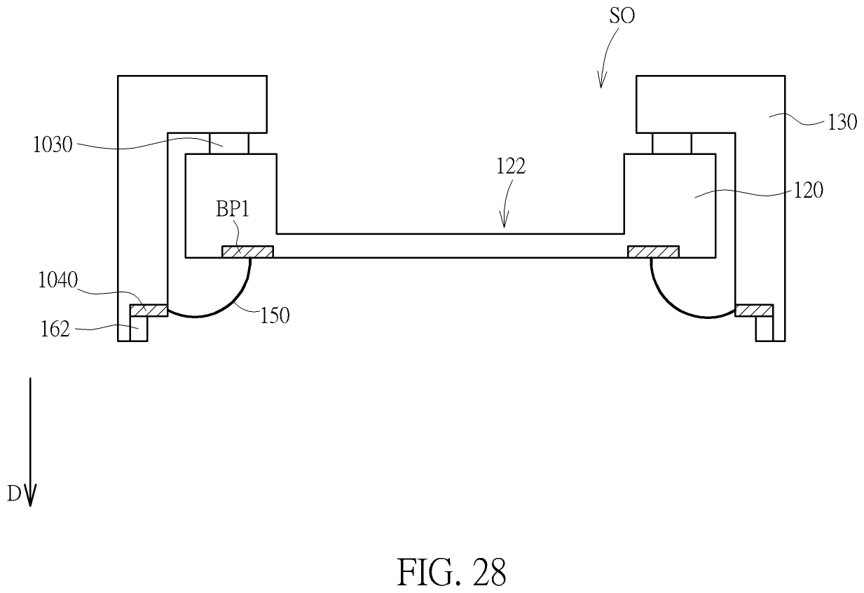

In FIG. 28, the cap 130 is provided, and the chip 120 and the cap 130 are connected to each other through the connecting component 1030. Furthermore, the electrical connection between the cap 130 and the chip 120 may be formed. Note that the materials, structures and types of the chip 120 and the cap 130 can be referred to in any suitable embodiment of the present invention, other content of the conductive component 150 can be referred to in any suitable embodiment of the present invention, and these will not be redundantly described.

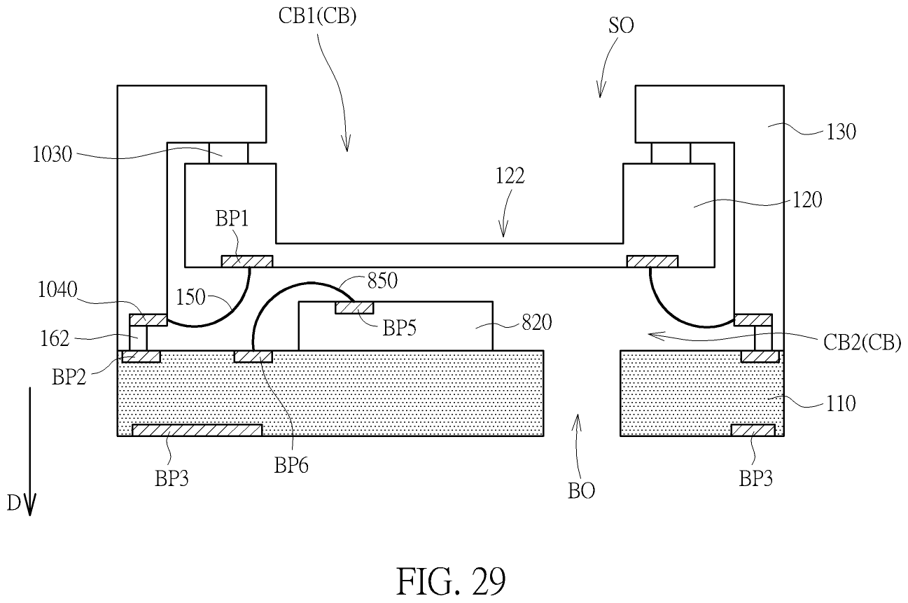

Then, in the steps ST2 and ST3 of FIG. 4, the chip 120 and the cap 130 are disposed on the base 110 (as shown in FIG. 29). More precisely, the cap 130 and the chip 120 are disposed on the base 110 at the same time. Optionally, in the step ST4 of FIG. 4, the first mesh 140 and the second mesh 142 are formed (as shown in FIG. 26). Note that the materials, structures and types of the first mesh 140 and the second mesh 142 can be referred to in any suitable embodiment of the present invention, and these will not be redundantly described. Therefore, the manufacture of the package structure 1000 shown in FIG. 26 is completed.

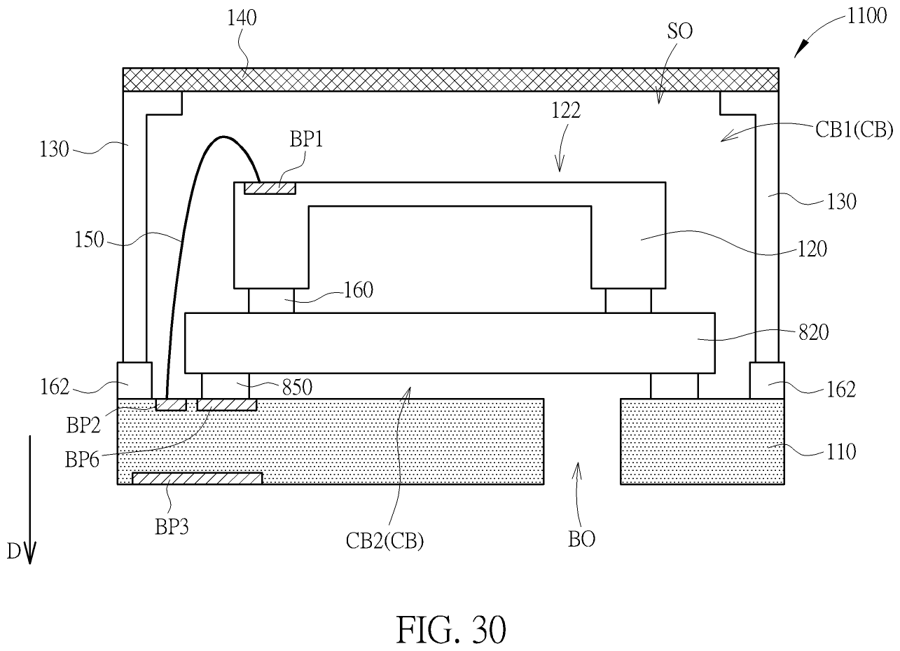

Referring to FIG. 30, FIG. 30 is a schematic diagram of a cross sectional view of a package structure of a sound producing device according to an eleventh embodiment of the present invention. As shown in FIG. 30, compared with the eighth embodiment, in the package structure 1100, the chip 120 may be disposed on the integrated circuit chip 820. In other words, the integrated circuit chip 820 may be disposed between the base 110 and the chip 120. Therefore, the lateral dimension of the package structure 1100 may be downsized due to the overlap of the chip 120 and the integrated circuit chip 820.

In summary, due to the present invention, the yield rate, the reliability and the uniformity of the package structure of the sound producing device is enhanced, the adverse impact of the dust and/or the liquid on the component in the package structure is decreased, and the package structure is downsized.

Those skilled in the art will readily observe that numerous modifications and alterations of the device and method may be made while retaining the teachings of the invention. Accordingly, the above disclosure should be construed as limited only by the metes and bounds of the appended claims.

1. A package structure of a sound producing device, comprising:
a base;
a cap disposed on the base;
a chip disposed on the base, wherein the chip comprises a thin film structure and an actuator configured to actuate the thin film structure, and the cap and the chip are on a same side of the base; and
a chamber formed by the base and the cap or formed by the base, the cap and the chip, wherein the thin film structure is disposed in the chamber,
wherein the cap has a sound outlet opening, and the base has a back opening;
wherein the chamber is separated into a first portion and a second portion by the thin film structure, and the thin film structure has direct contact with the first portion and the second portion of the chamber;
wherein the sound outlet opening is connected to the first portion of the chamber, and the back opening is connected to the second portion of the chamber.

2. (canceled)

3. The package structure of claim 1, further comprising a first mesh covering the sound outlet opening.

4. The package structure of claim 3, wherein the first mesh comprises metal, glass, semiconductor material, plastic, fabric or polymer.

5. The package structure of claim 1, wherein the actuator comprises a piezoelectric actuator, an electrostatic actuator, an electromagnetic actuator or an electrothermal actuator.

6. The package structure of claim 1, wherein the base further has a hollow portion comprising two ends, one of the ends of the hollow portion is connected to the back opening, and another one of the ends of the hollow portion extends to a sidewall of the base.

7. The package structure of claim 1, wherein the base is a substrate.

8. The package structure of claim 7, further comprising an integrated circuit chip disposed on the base.

9. The package structure of claim 1, wherein the base is an integrated circuit chip.

10. The package structure of claim 1, wherein the chip is connected to the cap through a connecting component.

11. The package structure of claim 1, further comprising a conductive component electrically connected between the actuator of the chip and the base.

12. The package structure of claim 11, wherein the chip comprises a hole passing through the chip, and the conductive component is disposed in the hole of the chip.

13. The package structure of claim 1, wherein the thin film structure is actuated to generate a plurality of air pulses, the air pulses are generated with a pulse rate, and the pulse rate is higher than a maximum human audible frequency.

14. A manufacturing method of a package structure of a sound producing device, comprising the following steps:
providing a base;
disposing a chip on the base, wherein the chip comprises a thin film structure and an actuator configured to actuate the thin film structure; and
disposing a cap on the base, wherein the cap and the chip are on a same side of the base,
wherein a chamber is formed by the base and the cap or formed by the base, the cap and the chip, the thin film structure is disposed in the chamber, the cap has a sound outlet opening, and the base has a back opening;
wherein the chamber is separated into a first portion and a second portion by the thin film structure, and the thin film structure has direct contact with the first portion and the second portion of the chamber;
wherein the sound outlet opening is connected to the first portion of the chamber, and the back opening is connected to the second portion of the chamber.

15. The manufacturing method of claim 14, further comprising:
forming a first mesh covering the sound outlet opening.

16. The manufacturing method of claim 14, further comprising:
forming a conductive component electrically connected between the actuator of the chip and the base.

17. The manufacturing method of claim 14, wherein before the step of disposing the chip on the base and the step of disposing the cap on the base, the manufacturing method further comprises:
connecting the chip and the cap through a connecting component.

18. The manufacturing method of claim 14, further comprises:
disposing an integrated circuit chip on the base.

19. The manufacturing method of claim 18, wherein the integrated circuit chip and the chip are on different sides of the base, the step of disposing the integrated circuit chip on the base is performed before disposing the chip on the base and disposing the cap on the base, and the manufacturing method further comprises:
forming a protecting layer on the base to cover the integrated circuit chip after disposing the integrated circuit chip on the base and before disposing the chip on the base and disposing the cap on the base.

20. A package structure of a sound producing device, comprising:
a base;
a chip disposed on the base, wherein the chip comprises a thin film structure and an actuator configured to actuate the thin film structure, and the chip has an opening corresponding to the thin film structure;
a first mesh disposed on the chip and covering the opening of the chip; and
a chamber formed by the base, the chip and the first mesh, wherein the thin film structure is disposed in the chamber,
wherein a sound outlet opening is the opening of the chip, and the base has a back opening;
wherein the chamber is separated into a first portion and a second portion by the thin film structure, and the thin film structure has direct contact with the first portion and the second portion of the chamber;
wherein the sound outlet opening is connected to the first portion of the chamber, and the back opening is connected to the second portion of the chamber.
